(19) United States
(12) Patent Application Publication
(10) Pub. No.: US 2008/0217981 A1
(43) Pub. Date: Sep. 11, 2008

(54) LEG REST FOR A STROLLER

(76) Inventor: Quoc-Thanh Ton-That, Old Orchard Beach, ME (US)

Correspondence Address: HAYES, SOLOWAY P.C., 175 CANAL STREET, MANCHESTER, NH, 03101, US

(21) Appl. No.: 11/681,999

(22) Filed: Mar. 5, 2007

(51) Int. Cl. B62B 7/14

(52) U.S. Cl. 297/423.4

(57) ABSTRACT

A removable leg rest for a stroller having a chassis made of chassis members. The removable leg rest comprises a support structure, at least one fastening mechanism and at least one angle adjusting mechanism. The support structure has a leg support surface. The fastening mechanism is attached to the support structure and is operative to fix the support structure to the chassis. The angle adjusting mechanism is used to set an angle of the support structure with respect to the chassis members.

### FIELD OF THE INVENTION

The present invention generally relates to the field of strollers. More specifically, the invention relates to a removable leg rest for strollers for babies or infants.

### BACKGROUND OF THE INVENTION

Strollers have greatly evolved in recent years. Their design has become more attractive and their level of practicality has increased. Especially, the new strollers are capable of folding more compactly on themselves. To this extent, two types of strollers exist: the carriage stroller, larger and equipped with all the bells and whistles, and the umbrella stroller, smaller, lighter and more spartan, but having the advantage of folding more compactly.

Umbrella strollers are especially appreciated when space is scarce in a car's trunk. They are also appreciated when a family wants to go out in particularly crowded places such as a shopping mall right before Christmas or a fair. After a couple of hours in the stroller, an infant may get tired and fall asleep, his feet falling off a small footrest equipping most of these umbrella strollers. When the infant is small, there may be no consequences. However, when the infant is taller, it is dangerous that his feet come in contact with the ground and harm himself as his feet are dragged along on the ground. Indeed, many of the umbrella strollers are not equipped with means to keep the legs of the infant from falling underneath the stroller. Furthermore, most of the umbrella strollers do not provide the option of supporting the legs of the infant at a set angle with respect to a stroller chassis, such as horizontally for example, should the infant want to sleep or want to rest more comfortably. Moreover, trading such an ill-equipped stroller for a better equipped model may not be an economically realistic option for many families.

There is therefore a need to retrofit a stroller with a means to substantially reduce the risk for an infant's legs from falling underneath the stroller. There is also a need to provide a leg support adapted to support the legs of the infant at a set angle with respect to the stroller chassis in order to provide more comfort.

### SUMMARY OF THE INVENTION

It is an object of the present invention to provide a removable leg rest for a stroller that, when installed, overcomes or mitigates one or more disadvantages of known umbrella strollers, or at least provides a useful alternative.

The invention provides the advantages of being capable of retrofitting different strollers with a means to reduce an infant's legs from falling underneath the stroller. The invention also provides the advantage of providing a leg support adapted to support the legs of the infant at a set angle with respect to the stroller chassis.

In accordance with an embodiment of the present invention, there is provided a removable leg rest for a stroller having a chassis made of chassis members. The removable leg rest comprises a support structure, at least one fastening mechanism and at least one angle adjusting mechanism. The support structure has a leg support surface. The fastening mechanism is attached to the support structure and is operative to fix the support structure to the chassis. The angle adjusting mechanism is used to set an angle of the support structure with respect to the chassis members.

### BRIEF DESCRIPTION OF DRAWINGS

These and other features of the present invention will become more apparent from the following description in which reference is made to the appended drawings wherein:

FIG. 1 is a perspective view of a leg rest in accordance with an embodiment of the present invention.

FIG. 2 is a perspective view of a leg rest in accordance with another embodiment of the present invention.

FIG. 3 is a perspective view of a leg rest in accordance with another embodiment of the present invention.

FIG. 4 is a perspective view of the leg rest of FIG. 2 installed on chassis members of a stroller.

FIG. 5 is a top view of the leg rest of FIG. 4.

FIG. 6 is a top view of a fastening mechanism installed on a chassis member of a stroller in accordance with another embodiment of the invention.

FIG. 7 is a perspective view of an angle adjusting mechanism in accordance with another embodiment of the invention.

FIG. 8a is a top view of a fastening mechanism and of an angle adjusting mechanism equipped with a quick release system in accordance with another embodiment of the invention.

FIG. 8b is a perspective view of the fastening mechanism and of the adjusting mechanism of FIG. 8a.

FIG. 9 is a perspective view of a leg rest in accordance with another embodiment of the invention.

FIG. 10 is a perspective view of a leg rest in accordance with another embodiment of the invention.

FIG. 11 is a perspective view of the leg rest of FIG. 10 installed on a stroller.

### DETAILED DESCRIPTION OF THE INVENTION

In the present description, the term stroller is understood to mean as much a stroller for a baby, a toddler or an infant.

The present invention provides a removable leg rest for a stroller, especially of the umbrella type not originally equipped with a leg rest. The removable leg rest of the present invention is adapted to fit to different models, configuration and sizes of strollers. The leg rest is adapted to be used as an accessory to the stroller and hence may be retrofitted to a stroller already owned by an owner.

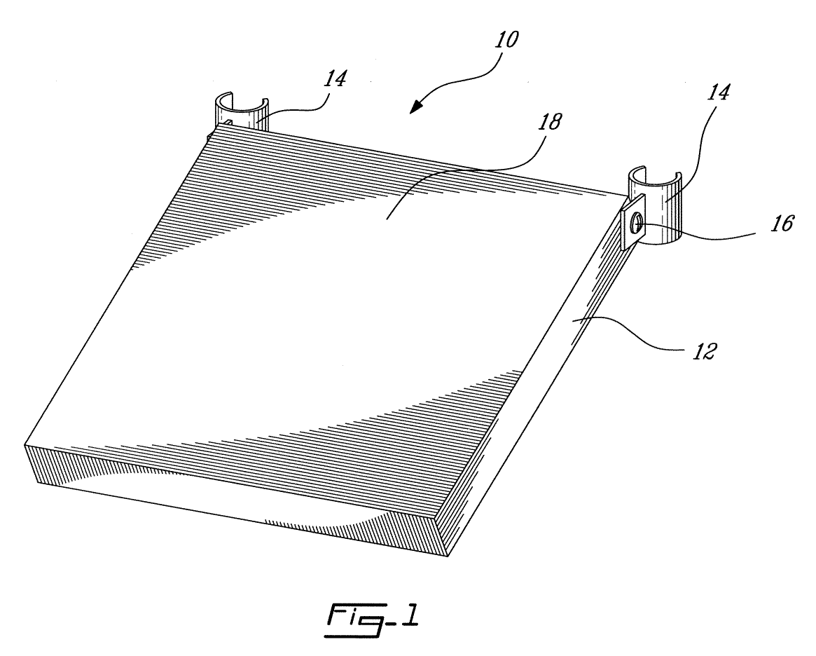

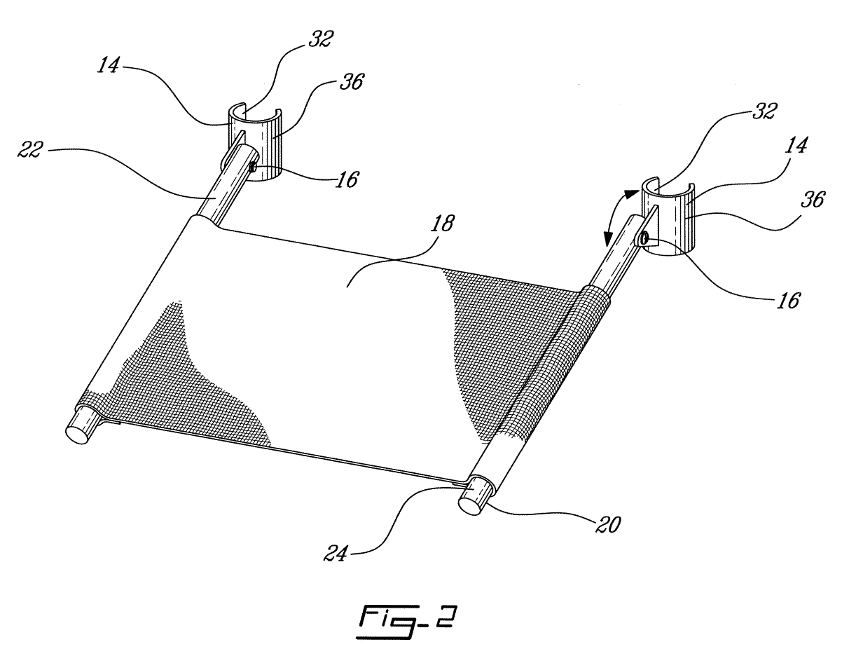

FIG. 1 depicts an example of the removable leg rest for a stroller. The removable leg rest 10 comprises a support structure 12, fastening mechanisms 14 and angle adjusting mechanisms 16. The support structure 12 has a leg support surface 18 which comes into contact with the legs of an infant taking place in the stroller. The support structure 12 may be rigid and self-supporting. In this case, the support surface 18 may directly be a face of the support structure 12 or a soft surface, such as a cushion, which is then considered as part of the support structure 12. Alternatively, and as shown in FIG. 2, which is concurrently referred to, the support structure 12 may be made of a frame 20, itself made of a right frame member 22 and a left frame member 24. The angle adjusting mechanisms 16 and the fastening mechanism 14 are attached close to an extremity of both the right frame member 22 and the left frame member 24.

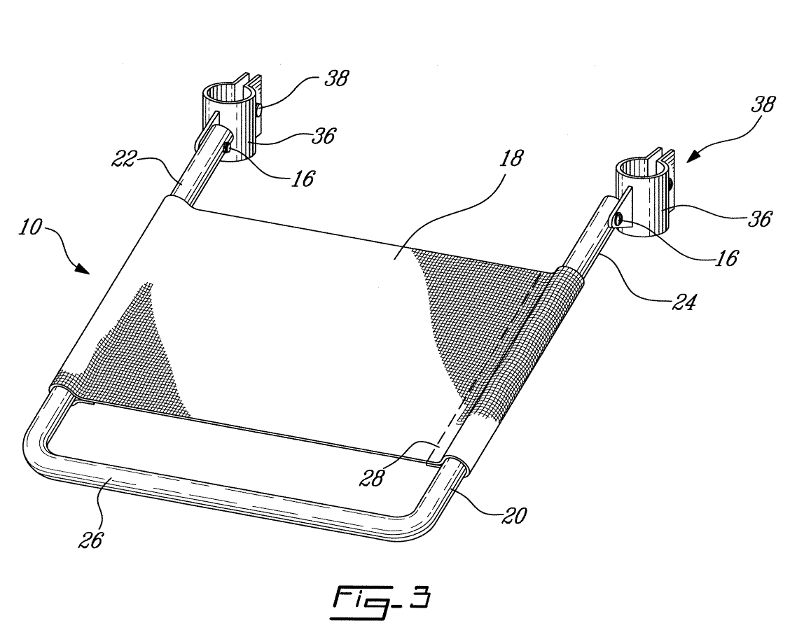

FIG. 3 is now concurrently referred to. Optionally, the right and the left frame members 22, 24 may be connected by a transverse frame member 26. The transverse frame member 26 rigidifies the frame 20. However, it may be beneficial to use the type of frame without the transverse frame member 26 if the user wants to be able to fold his stroller without removing the removable leg support 10 from the stroller. The leg support surface 18 may be made of a flexible material, which extends between the right and the left frame members 22, 24. Since not all models of strollers are of the same width, it is convenient that the leg support surface 18 be equipped with width adjusting means 28 so that it is always tight and capable of supporting the weight of an infant's legs without sagging significantly. Many width adjusting means 28 exist. For example, one may use a stretchable fabric. Alternatively, mating strips of Velcro® may be placed on a reverse side of the leg support surface 18 so that when the right and left frame members 22, 24 are attached to a chassis of the stroller, the leg support surface 18 is tightened over the right and left frame members 22, 24 by circumventing each of them with the leg support surface 18 and attaching the mating Velcro® strips together.

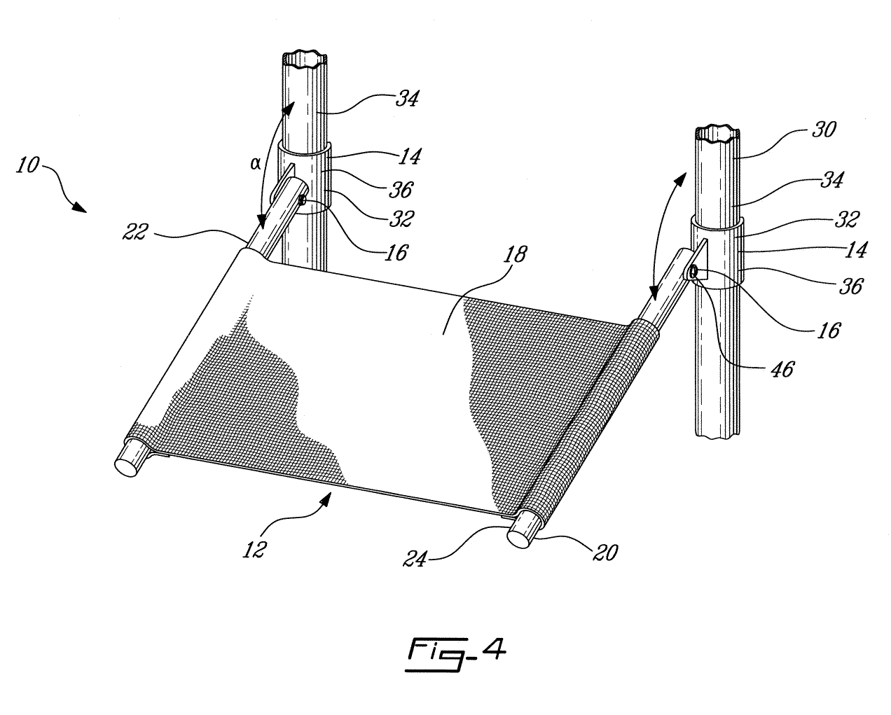

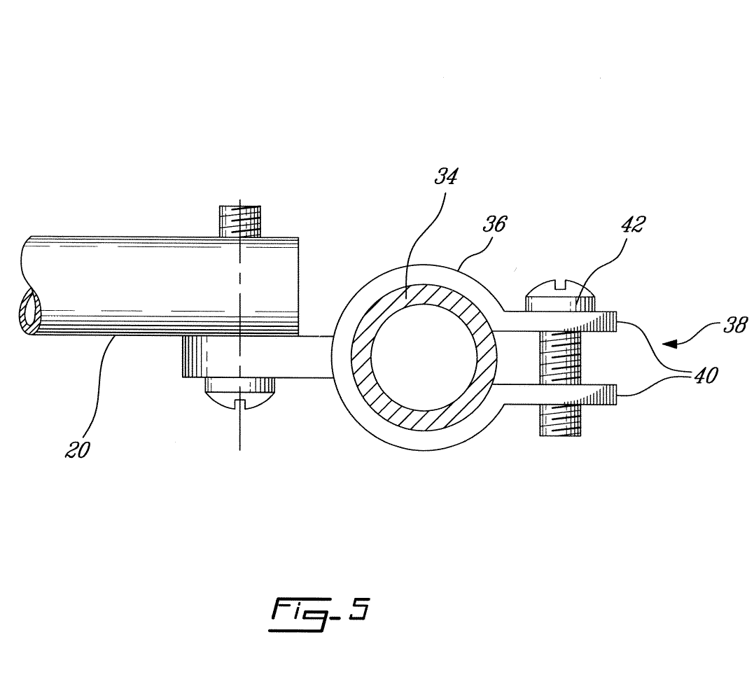

FIG. 4 is now concurrently referred to. The fastening mechanisms 14 are used to secure the support structure 12 to a stroller chassis 30, as shown. Depending on the design of the removable leg rest 10, one or more fastening mechanisms 14 may be used. The fastening mechanisms 14 are typically installed close to an extremity of the support structure 12. The fastening mechanisms 14 comprise a grabbing portion 32 to grab a chassis member 34 of the stroller chassis 30. This chassis member 34 may be of different sizes. Again, a person skilled in the art could imagine many different designs of fastening mechanisms 14 and grabbing portions 32. For example, the grabbing portion 32 could be made of a deformable C-shaped portion 36. When pressed over the chassis member 34, this C-shaped portion 36 deforms to clip over the chassis member 34 and conforms to it. The removable leg rest 10 is then removably attached to the stroller chassis 30. Again, this type of grabbing mechanisms is well known in the art and there is no need to describe it in further details. In order to provide a more positive attachment, the fastening mechanism may comprise a locking element 38, shown in FIG. 5 and concurrently referred to, which retains the chassis member 34 in the C-shaped portion 36. In this example, the edges of the C-shaped portion 36 are extended further such as to provide lips 40 adapted to receive a locking means 42, such as a screw or other fastener, to keep both lips 40 attached together.

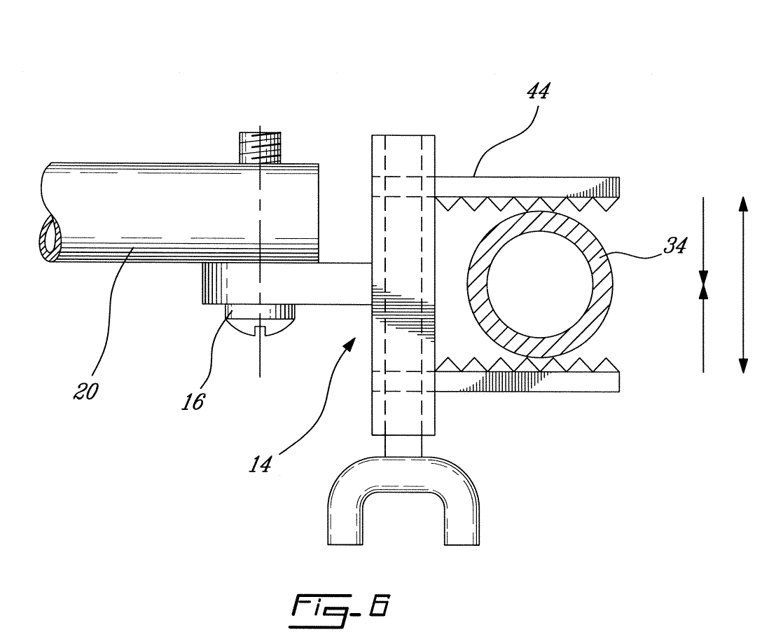

As best shown in FIG. 6, which is concurrently referred to, the fastening mechanism 14 may alternatively comprise a vise 44 capable of at least partially circumventing and grabbing various sizes of chassis members 34. Vises are well known in the art and will not be described in further details herein.

As best shown in FIG. 4, the angle adjusting mechanism 16 is used to set the removable leg rest 10 at an angle α with respect to the chassis members 34. This angle adjusting mechanism 16 may take the form of a simple screw 46, which attaches the fastening mechanism 14 to the support structure 12. In the present case, the support structure 12 is kept at an angle with respect to the chassis members 34 by a friction force between the support structure 12 and the fastening mechanism 14. This friction force is developed by applying a torque to the screw 46. At least one angle adjusting mechanism 16 is required. However, more than one may be used. The angle adjusting mechanism 16 must be capable preventing a substantial change in the angle α when a load of an infant's legs is applied on the leg support surface 18. However, the angle adjusting mechanism may allow the angle α to change when subjected to a higher load, for example, when an infant's parent pulls on the leg support surface 18 with the intent of altering the angle α.

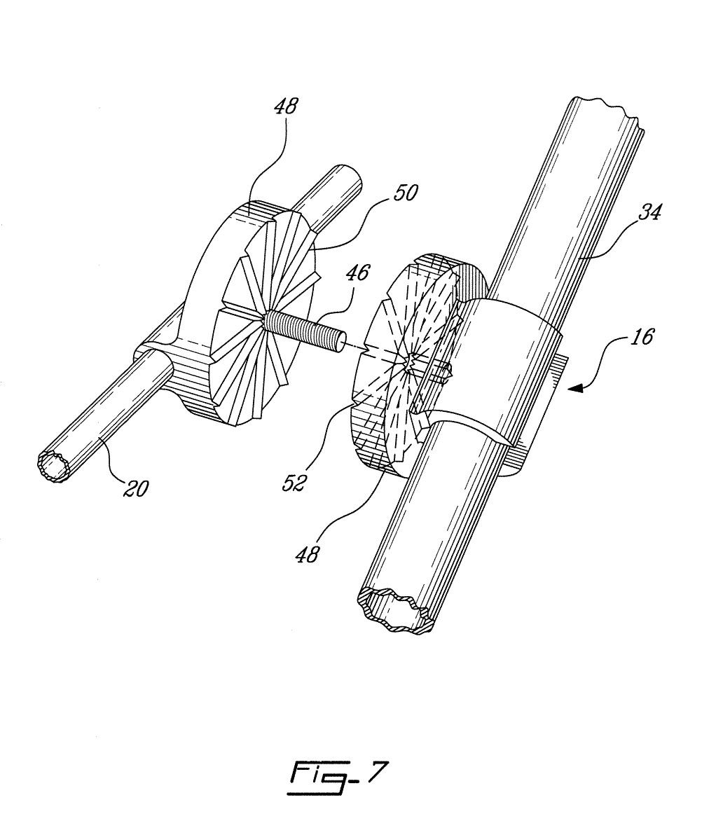

Alternatively, the angle adjusting mechanism 16 may be designed so that it rotates with pre-set angle increments. Turning now to FIG. 7, there is shown an example of an embodiment of such an angle adjusting mechanism 16. Here, the angle adjusting mechanism 16 is made of two halves 48 having matching radial bosses 50 and grooves 52. When the screw 46 is unscrewed, one half 48 may be angularly positioned with respect to the other half 48 so that the frame 20 is at a desired angle with the chassis member 34. Torque is then applied to the screw 46 so that both halves 48 come into contact, the bosses 50 matching the grooves 52.

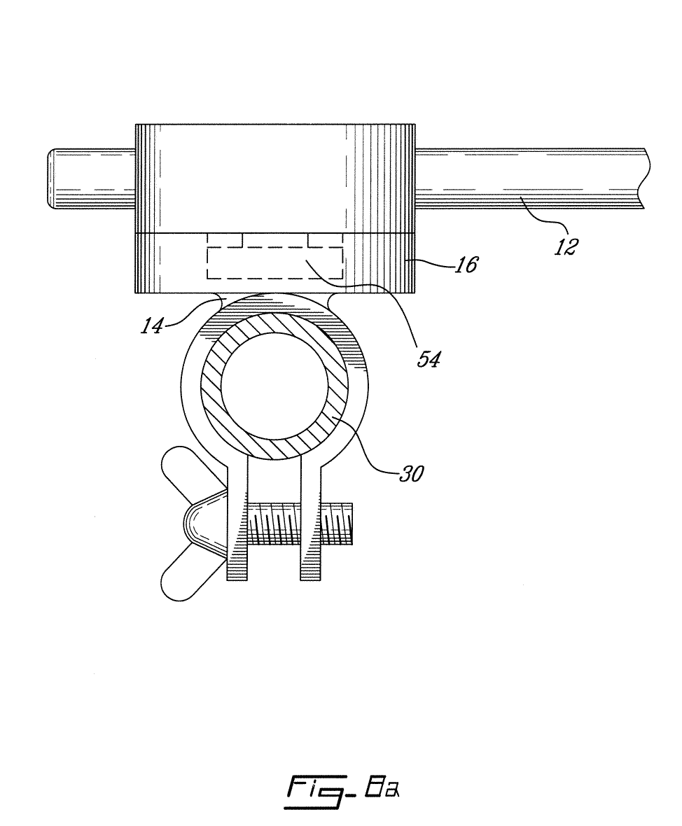

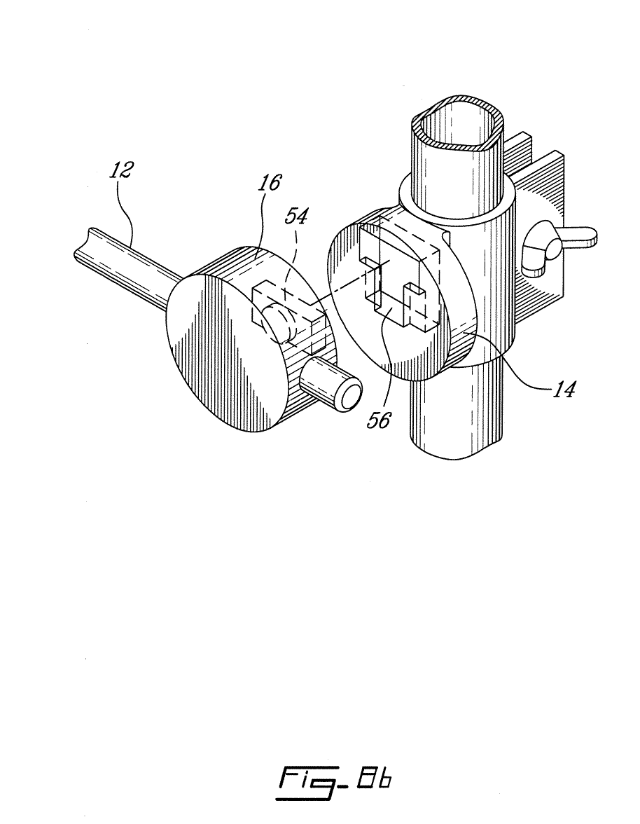

To save on production costs, the angle adjusting mechanism 16 may be partially integrated with the support structure 12 and partially integrated with the fastening mechanism 14. Optionally, a quick release mechanism between the fastening mechanism 14 and the angle adjusting mechanism 16 may be used to quickly disengage the angle adjusting mechanism 16 and the support structure 12 from the fastening mechanism 14 and the stroller chassis 30. FIGS. 8a and 8b depict an example of such a quick release system where a T-shape anchor 54 protruding from the angle adjusting mechanism 16 enters a slot 56 in the fastening mechanism 14. The fastening mechanism 14 may therefore remain permanently installed on the stroller.

Conveniently, the angle adjusting mechanism 16 may be an assembly that comprises a spring-loaded button activating a locking mechanism. When the button is in its normally released position, the angle adjusting mechanism 16 is locked in position at a given angle α. When the button is pressed, the locking mechanism is disengaged, which allows the angular adjustment of the angle adjusting mechanism 16. Many variations of such mechanisms exist and are well known in the art and will therefore not be described in any further length.

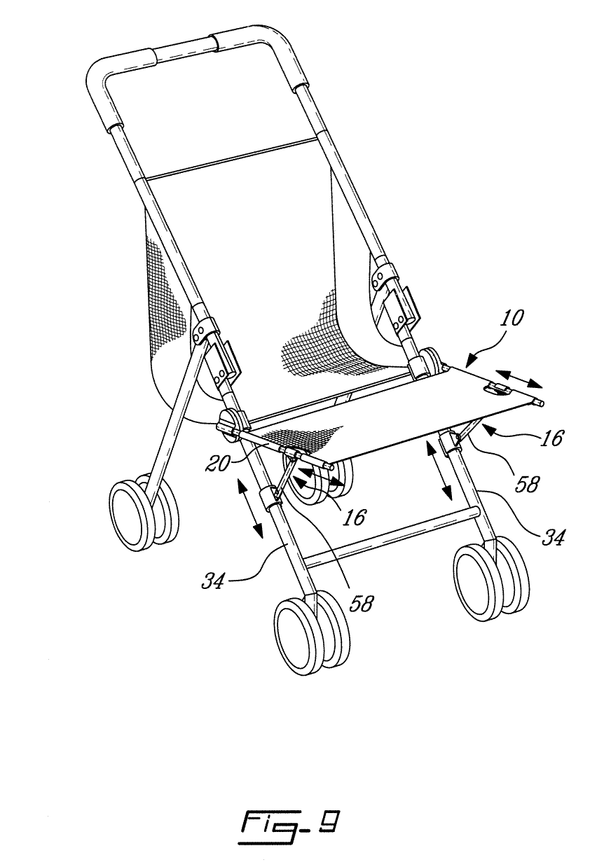

FIG. 9 shows yet another type of angle adjusting mechanism 16. The removable leg rest 10 is shown installed on the stroller. In this embodiment of the invention, the angle adjusting mechanism 16 takes the shape of a rod 58 attached to the frame 20 at one of its extremities and to one of the chassis members 34 at its other extremity. The angle of the removable leg rest 10 may be adjusted by sliding either one or the other of the rod extremities on either the frame 20 or the chassis member 34.

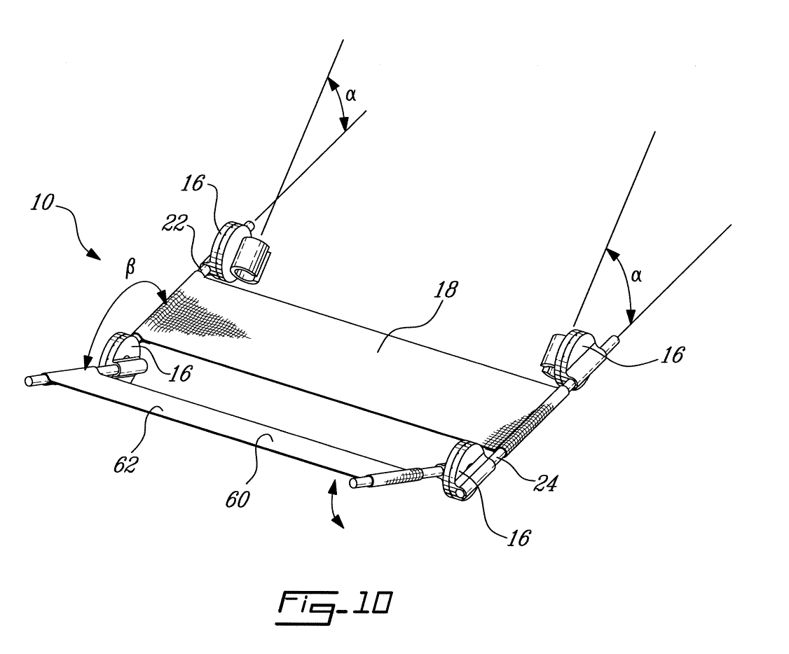

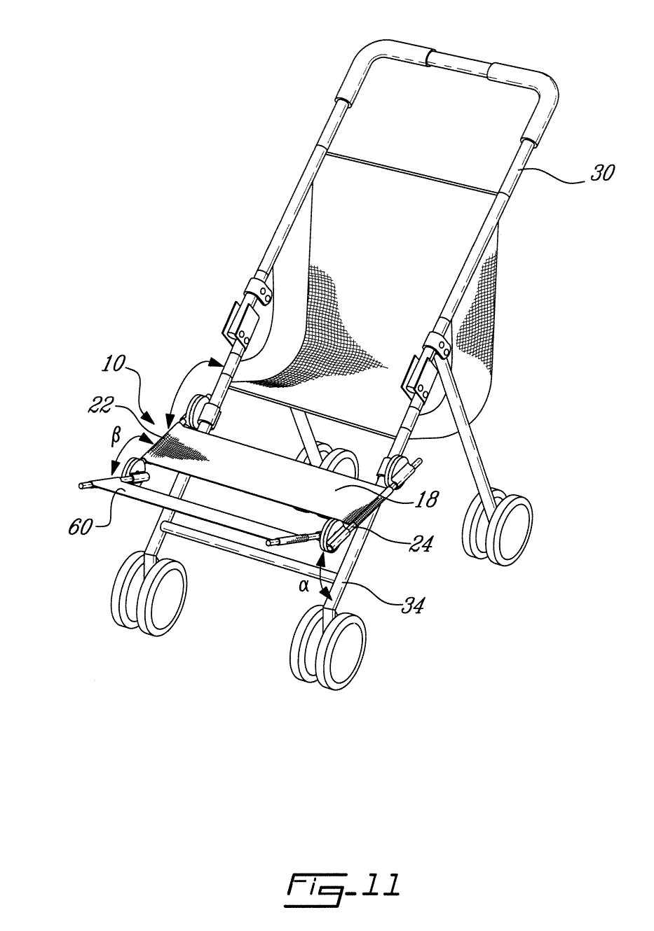

We now turn concurrently to FIGS. 10 and 11 which depict another variation of the invention. In this case, the right and the left frame members 22, 24 of the removable leg rest 10 are equipped between their extremities with a second set of angle adjusting mechanisms 16. This provides a footrest portion 60 which angle β, defined as the angle between the leg support surface 18 and the footrest surface 62 of the footrest portion 60, may be adjusted. Hence, the removable leg rest 10 not only provides support for the infant's legs, but may also support his feet.

The present invention has been described with regard to preferred embodiments. The description as much as the drawings were intended to help the understanding of the invention, rather than to limit its scope. It will be apparent to one skilled in the art that various modifications may be made to the invention without departing from the scope of the invention as described herein, and such modifications are intended to be covered by the present description.

1. A removable leg rest for a stroller having a chassis made of chassis members, the leg rest comprising:
a support structure having a leg support surface;
at least one fastening mechanism attached to said support structure, said fastening mechanism being operative to fix said support structure to the chassis of the stroller; and
at least one angle adjusting mechanism for setting an angle of said support structure with respect to the chassis members.

2. The leg rest of claim 1 wherein said angle adjusting mechanism has pre-set angle increments.

3. The leg rest of claim 1 wherein said fastening mechanism comprises a grabbing portion operative to grab chassis members of different sizes.

4. The leg rest of claim 3 wherein said grabbing portion comprises a deformable C-shaped portion for grabbing the chassis members.

5. The leg rest of claim 4 wherein said fastening mechanism further comprises a locking element for retaining the chassis member in said C-shaped portion.

6. The leg rest of claim 3 wherein said fastening mechanism comprises a vise capable of at least partially circumventing and grabbing various sizes of chassis members.

7. The leg rest of claim 1 wherein said support structure comprises a frame.

8. The leg rest of claim 7 wherein said frame comprises a right and a left frame member, each of said right and left frame members being equipped proximate a first extremity wit one of said at least on angle adjusting mechanism and one of said at least one fastening mechanism.

9. The leg rest of claim 8 wherein each of said right and left frame members are equipped between said first extremity and a second extremity with a second one of said at least one angle adjusting mechanism.

10. The leg rest of claim 9 wherein said right and left frame members are connected by a transverse frame member.

11. The leg rest of claim 8 wherein said leg support surface is made of a flexible material extending between said right and said left frame members.

12. The leg rest of claim 11 wherein said leg support surface is equipped with a width adjusting means to adjust the width of the leg support surface between said right an said left frame members.

13. The leg rest of claim 12 wherein the width adjusting means are mating Velcro® strips placed on a side of said leg support surface so when said right and said left frame members are attached to the chassis, said leg support surface is tightened over said right and said left frame members by circumventing each of said right and said left frame members with said leg support surface and attaching said mating Velcro® strips together.

14. The leg rest of claim 13 wherein said leg support surface material is a fabric.

15. The leg rest of claim 1 further comprising a quick release mechanism between said fastening mechanism and said adjusting mechanism for quickly releasing said adjusting mechanism and said support structure from said fastening mechanism.

16. The leg rest of claim 2 wherein said angle adjusting mechanism comprises a spring-loaded button operative to normally lock a angular adjustment of said angle adjusting mechanism and to allow said angular adjustment of said angle adjusting mechanism when pressed.

17. The leg rest of claim 1 wherein the fastening mechanism is attached to a substantially vertical chassis member of the stroller at a middle portion of said chassis member.

18. The leg rest of claim 1 wherein said angle adjusting mechanism further comprises a fastening element, slidably fixed to the chassis member.

19. The leg rest of claim 1, wherein the angle adjusting mechanism further comprises a rod having a first connection to the support structure at a proximal end of the rod and a second connection to the chassis member at a distal end of the rod, wherein at least one of the connections is a slidable connection.
